(19) United States
(12) Patent Application Publication
(10) Pub. No.: US 2013/0273238 A1
(43) Pub. Date: Oct. 17, 2013

(54) Inverted Curing of Liquid Optoelectronic Lenses

(71) Applicants: Peter S. Andrews, Durham, NC (US); Luis Adames, Raleigh, NC (US)

(72) Inventors: Peter S. Andrews, Durham, NC (US); Luis Adames, Raleigh, NC (US)

(21) Appl. No.: 13/447,959

(22) Filed: Apr. 16, 2012

(51) Int. Cl. B05D 3/02; B05D 5/06; B05D 5/00

(52) U.S. Cl. 427/58; 427/162

(57) ABSTRACT

A method of forming a lens over an optoelectronic element includes providing the optoelectronic element on a support substrate, dispensing a quantity of encapsulant onto the support substrate over the optoelectronic element, inverting the support substrate so that the support substrate is above the optoelectronic element and the encapsulant is suspended from the support substrate, and curing the encapsulant while maintaining the support substrate in the inverted position.

### FIELD

The present invention relates to optoelectronic device packaging, and in particular relates to the formation of lenses for optoelectronic device packages.

### BACKGROUND

Light emitting diodes and laser diodes are well known solid state electronic devices capable of generating light upon application of a sufficient voltage. Light emitting diodes and laser diodes may be generally referred to as light emitting devices (“LEDs”). Light emitting devices generally include a p-n junction formed in an epitaxial layer grown on a substrate such as sapphire, silicon, silicon carbide, gallium arsenide and the like. The wavelength distribution of the light generated by the LED generally depends on the material from which the p-n junction is fabricated and the structure of the thin epitaxial layers that make up the active region of the device.

Typically, an LED includes a substrate, an n-type epitaxial region formed on the substrate and a p-type epitaxial region formed on the n-type epitaxial region (or vice-versa). In order to facilitate the application of a voltage to the device, an anode ohmic contact is formed on a p-type region of the device (typically, an exposed p-type epitaxial layer) and a cathode ohmic contact is formed on an n-type region of the device (such as the substrate or an exposed n-type epitaxial layer).

In order to use an LED in a circuit, it is known to enclose an LED in a package to provide environmental and/or mechanical protection, color selection, focusing and the like. An LED package also includes means, such as electrical leads or traces, for electrically connecting the LED chip to an external circuit. In a typical package 10 illustrated in FIG. 1A, an LED 12 is mounted on a reflective cup 13 by means of a solder bond or conductive epoxy. One or more wirebonds connect the ohmic contacts of the LED 12 to leads 15A, 15B, which may be attached to or integral with the reflective cup 13. The reflective cup may be filled with an encapsulant material 16 containing a wavelength conversion material, such as a phosphor. Light emitted by the LED at a first wavelength may be absorbed by the phosphor, which may responsively emit light at a second wavelength. The entire assembly is then encapsulated in a clear protective resin 14, which may be molded in the shape of a lens to collimate the light emitted from the LED chip 12. While the reflective cup may direct light in an upward direction, optical losses may occur when the light is reflected (i.e. some light may be absorbed by the reflector cup instead of being reflected).

In another conventional package 20 illustrated in FIG. 1B, a plurality of LED chips 22 are mounted onto a printed circuit board (PCB) carrier 23. One or more wirebond connections are made between ohmic contacts on the LEDs 22 and electrical traces 25A, 25B on the PCB 23. Each mounted LED 22 is then covered with a drop of clear resin 24, which may provide environmental and mechanical protection to the chips while also acting as a lens. The individual packaged LEDs 22 may then be separated by sawing the PCB carrier 23 into small squares, each of which contains one or more LED chips 22.

A lens may also be formed on an optoelectronic device by molding the lens onto a support substrate on which the optoelectronic device is mounted.

Conventional apparatus/methods for forming molded lenses on a support substrate are illustrated in FIGS. 2A to 2C. Referring to FIG. 2A, a mold is provided including an upper mold body 202 and a lower mold body 204. The lower mold body 204 includes a plurality of recesses 205 formed therein. A liquid encapsulant material 210 is dispensed over the lower mold body 204 and into the recesses 205.

A support substrate 100 including a plurality of optoelectronic devices 120 mounted thereon is placed between the lower mold body 204 and the upper mold body 202 so that the optoelectronic devices 120 are positioned above respective ones of the recesses 205. Precise placement of the optoelectronic devices 120 on the support substrate 100 and alignment of the support substrate 100 relative to the recesses 205 is required to ensure that lenses are formed directly over the optoelectronic devices 120. If the lenses are formed in an offset position, e.g. so that the lenses are not centered over the optoelectronic devices, the far field emission pattern of the devices may be degraded.

The upper and lower mold bodies 202, 204 are brought together and compressed with a large force. Heat may be applied to the mold, causing the encapsulant material to cure and form dome shaped lenses to 220 over the optoelectronic elements 120 on the support substrate 100.

As shown in FIG. 2C, a large portion of the support substrate 100, represented by the shaded area 225, is unusable, because the force applied between the mold bodies 202, 204 would crush any devices or other objects placed there, and/or because the space is needed by the molding system for holding the support substrate 100 in place and aligning the support substrate.

Lenses can also be formed over optoelectronic devices mounted on support substrates by dispensing liquid encapsulant materials in precise quantities within an encapsulant region on the support substrate.

For example, FIG. 3 illustrates a packaged optoelectronic device including an encapsulant dome that is formed by dispensing a liquid encapsulant and curing the dispensed liquid encapsulant. As shown therein, a support substrate 100 is provided. An encapsulant dam 162 defines an encapsulant area 126 on the support substrate into which a liquid encapsulant material, such as liquid silicone, is dispensed.

An optoelectronic device 120 is mounted on the support substrate 100 within the encapsulant region 126. The optoelectronic device may be mounted on one or more die attach pads (not shown), and may be attached to electrical vias (not shown) or other electrical connections in/on the support substrate 100 by means of wire bonds (not shown), electrical traces or other electrical connectors.

To encapsulate the optoelectronic element 120, a liquid encapsulant, such as silicone, is dispensed into the encapsulant region 126. When the liquid encapsulant is dispensed into the encapsulant region 126, the liquid encapsulant flows over the optoelectronic element 120 and along the surface of the support substrate 100 until it reaches the encapsulant dam 162, which limits the flow of liquid encapsulant. Surface tension in the liquid encapsulant causes the liquid encapsulant to form a convex dome shaped lens 124 over the optoelectronic element. A sufficient amount of liquid encapsulant material is dispensed so that the dome is formed to a desired height above the support substrate 100.

The liquid encapsulant is then cured, for example by heating the liquid encapsulant at a sufficient temperature for a sufficient time for polymers in the liquid encapsulant to link together and solidify. The cured liquid encapsulant forms a solid dome lens 24 above the optoelectronic device.

In some cases, it is desirable for the dome lens to have a hemispherical shape. Assuming the optoelectronic device exhibits lambertian emission characteristics, a hemispherical dome lens may increase light extraction from the device package and/or may reduce far-field distortion in the light emission of the device package.

As shown in FIG. 3, however, when the liquid encapsulant is dispensed, the convex dome of liquid may not have a perfectly hemispherical shape. In particular, the dome lens 124 may have a height H that is less than half of the diameter D of the dome lens 24. Stated differently, the diameter D of the dome lens 124 may be more than twice the height H of the lens, which causes the lens to have a flattened shape rather than a hemispherical shape. Such a lens shape may reduce light extraction from the device package and/or cause undesirable distortion in the far-field emission pattern of the device package.

### SUMMARY

A method of forming an optoelectronic device includes providing an optoelectronic element on a support substrate, dispensing a quantity of liquid encapsulant onto the support substrate over the optoelectronic element so that the liquid encapsulant forms a dome over the optoelectronic element, inverting the support substrate so that the support substrate is above the optoelectronic element and the liquid encapsulant is suspended from the support substrate, and curing the liquid encapsulant while maintaining the support substrate in the inverted position.

The method may further include pre-curing the liquid encapsulant dome before inverting the support substrate. As used herein, “pre-curing” refers to any process of treating a curable liquid that results in increasing the viscosity of the liquid by initiating a cross-linking process in the liquid. Pre-curing can include, but is not limited to, heating the liquid, allowing the liquid to sit for a predetermined time, subjecting the liquid to a vacuum to reduce entrapped air, etc.

The method further may further include providing an encapsulant dam on the support substrate, the optoelectronic element is mounted within an encapsulant region bounded by the encapsulant dam. Dispensing the quantity of liquid encapsulant may include dispensing the quantity of liquid encapsulant within the encapsulant region.

Providing the encapsulant dam on the support substrate may include dispensing a liquid polymer onto the support substrate in a closed or interrupted pattern that defines the encapsulant region.

The pattern may form a circle on the support substrate. In some embodiments, the pattern may be non-circular.

The liquid polymer may include a silicone.

The liquid encapsulant may include a second silicone that is different than the silicone of the liquid polymer. In particular, the silicone of the liquid polymer has a different surface tension than the second silicone of the liquid encapsulant. In some embodiments, the silicone of the liquid polymer may include a methyl silicone and the second silicone of the liquid encapsulant may include a phenyl silicone.

The quantity of liquid encapsulant may be large enough that when the liquid encapsulant cures, the dome formed by the liquid encapsulant has a height above the support substrate that is at least half of a maximum width of the dome.

The height of the dome formed by the liquid encapsulant may in some embodiments be greater than half of the maximum width of the dome.

The method may further include bringing the encapsulant dome into contact with a curing plate while the support substrate is in the inverted position.

The liquid encapsulant may include wavelength conversion particles and/or light scattering particles, such as Al₂O₃, TiO₂, etc., which can also act as a thixotrope if needed.

Curing the liquid encapsulant may include curing the liquid encapsulant while the encapsulant dome is in contact with the curing plate.

The method may further include heating the curing plate while the encapsulant dome is in contact with the curing plate.

A method of forming a lens for an optoelectronic device includes dispensing a quantity of liquid encapsulant onto a support substrate so that the liquid encapsulant forms a dome, inverting the support substrate so that the liquid encapsulant is suspended from the support substrate, and curing the liquid encapsulant while maintaining the support substrate in the inverted position.

A method of forming an optical element according to some embodiments includes providing a quantity of optical material on a support substrate, and positioning the support substrate an a non-normal orientation to shape the optical element.

It is noted that aspects of the invention described with respect to one embodiment may be incorporated in a different embodiments although not specifically described relative thereto. That is, all embodiments and/or features of any embodiments can be combined in any way and/or combination. These and other objects and/or aspects of the present invention are explained in detail in the specification set forth below.

Other methods according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIGS. 1A and 1B illustrate conventional packages for optoelectronic devices.

FIGS. 2A to 2C illustrate conventional methods of forming compression molded lenses on optoelectronic devices.

FIG. 3 illustrates a conventional dispensed lens on an optoelectronic device.

FIGS. 4-7 illustrate formation of a dispensed lens on an optoelectronic device in accordance with some embodiments.

FIG. 8 is a graph of lens height versus dispense step for a dispensed lens fabricated in accordance with some embodiments.

FIG. 9 illustrates a dispensed lens on an optoelectronic device in accordance with further embodiments.

FIGS. 10-13 illustrate formation of a dispensed lens on an optoelectronic device in accordance with further embodiments.

FIGS. 14 and 15 illustrate dispensed lenses formed in accordance with some embodiments having non-circular shapes.

FIGS. 16-18 illustrate formation of a dispensed lens on an optoelectronic device in accordance with further embodiments.

FIG. 19 is a flowchart that illustrates systems/methods for forming a dispensed lens on an optoelectronic device in accordance with further embodiments.

FIGS. 20A-20C illustrate formation of a dispensed lens on an optoelectronic device in accordance with further embodiments.

FIGS. 21A-21C illustrate encapsulant dams formed in accordance with some embodiments.

FIGS. 22A-22C illustrate formation of asymmetrical lenses in accordance with some embodiments.

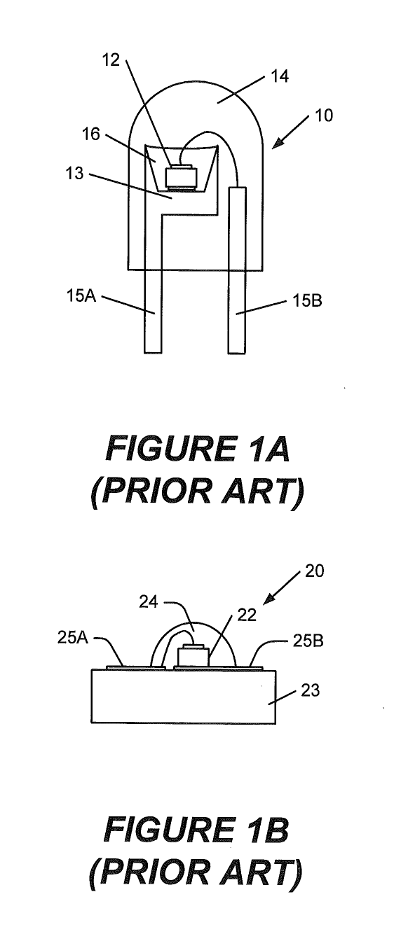

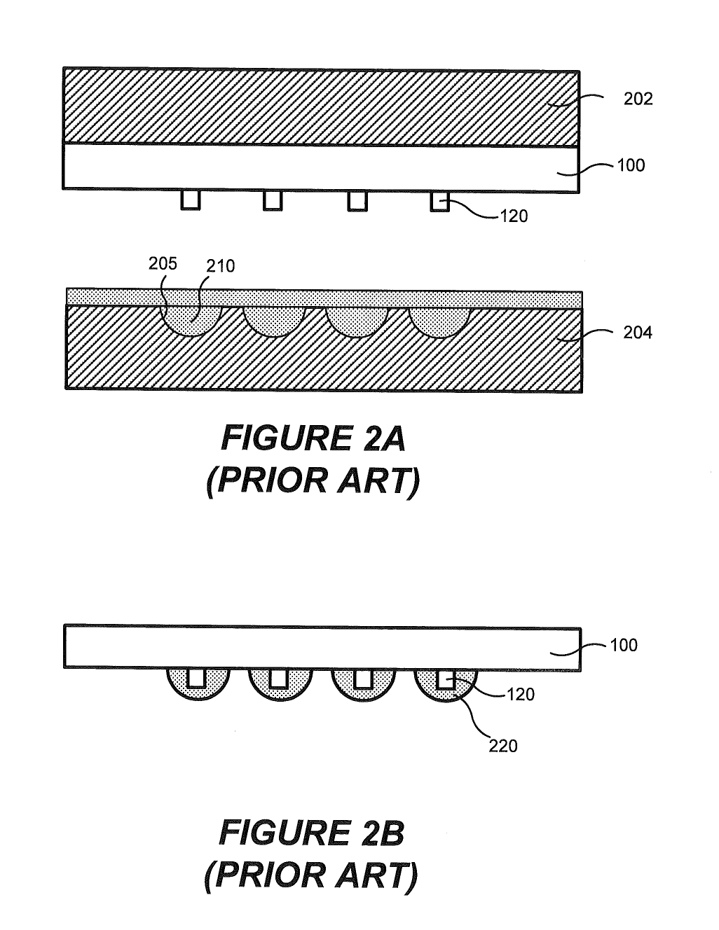

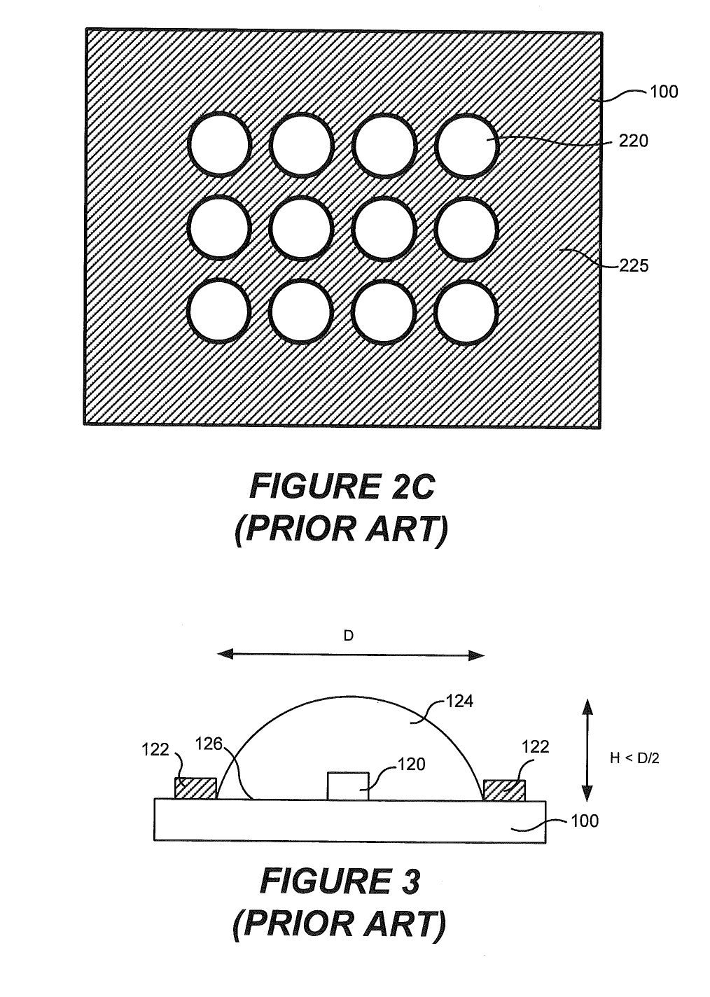

### DESCRIPTION OF EMBODIMENTS

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

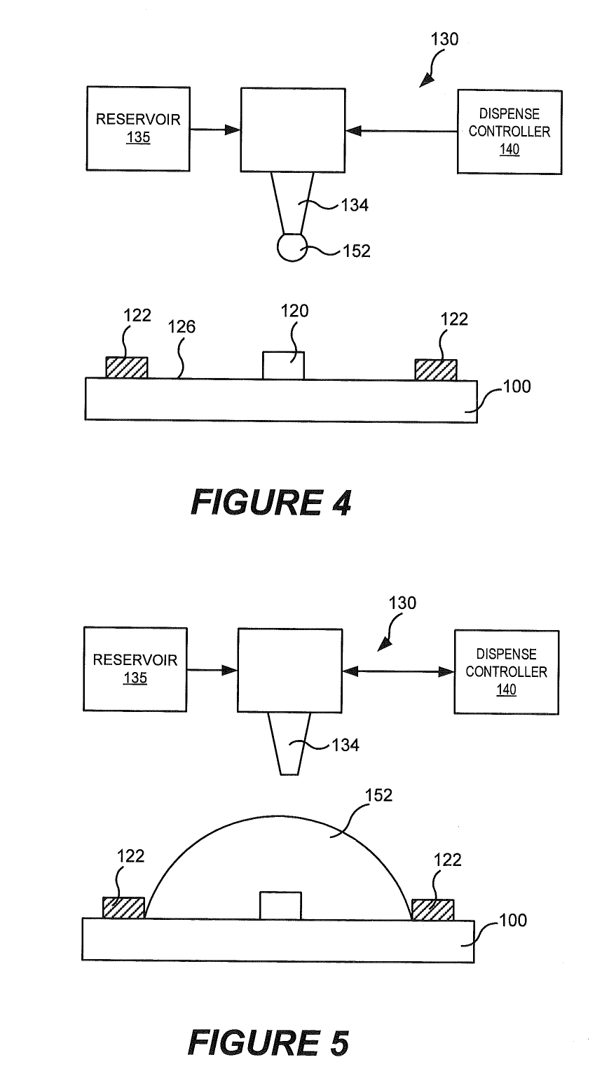

Various embodiments of the invention will now be described with reference to FIGS. 4 through 19.

According to some embodiments, a lens may be formed over an optoelectronic element by dispensing an encapsulant over the optoelectronic element, inverting the optoelectronic element, and curing the dispensed encapsulant in an inverted orientation.

Referring to FIGS. 4 to 7, a support substrate 100 is provided. The support substrate 100 may be a printed circuit board, a copper or aluminum plate, an alumina substrate, etc. An encapsulant dam 162 may be provided on the support substrate. The encapsulant dam 162 defines an encapsulant area 126 on the support substrate into which a liquid encapsulant material, such as liquid silicone, is dispensed.

In general, the encapsulant dam is used to retain the liquid encapsulanta in a desired location on the support substrate. However, embodiments of the invention can use other encapsulant retention, depositing or shaping techniques to position the encapsulant in the appropriate way to obtain a final desired lens shape.

Referring again to FIGS. 4 to 7, the encapsulant dam 162 may be formed by depositing a film, such as a metal film, a polymer film, etc., and patterning the film to form the encapsulant dam 162. The encapsulant area 126 is typically circular when viewed in plan view from above the support substrate; however, other shapes may be used to obtain a desired lens shape and/or emission pattern from the packaged device.

One or more optoelectronic devices 120 is/are mounted on the support substrate 100 within the encapsulant region 126. The optoelectronic device 120 may be mounted on one or more die attach pads (not shown), and may be attached to electrical vias (not shown) or other electrical connections in/on the support substrate 100 by means of wire bonds (not shown), electrical traces or other electrical connectors.

To encapsulate the optoelectronic device 120, an optical material, such as a liquid encapsulant 152, is dispensed into the encapsulant region 126 by means of a dispensing system 130 including a dispensing nozzle 134, a reservoir 135 and a dispense controller 140. The liquid encapsulant 152 may include liquid silicone. The dispense controller 140 controls the three dimensional positioning of the dispensing nozzle 134 over the support substrate 100. The dispense controller 140 also precisely controls the amount of liquid encapsulant material that is dispensed.

Suitable dispensing systems are manufactured, for example, by Ivek Corporation, North Springfield, Vt. Other suitable dispensing systems are manufactured by Musashi Engineering, Nordson EFD, ASM, Asymtek, GPM, DL Technologies, and others. Such dispensing systems may be capable of controlling the amount of liquid dispensed with sub-microliter precision.

When the liquid encapsulant 152 is dispensed into the encapsulant region 126, the liquid encapsulant 152 flows over the optoelectronic element 120 and along the surface of the support substrate 100 until it reaches the encapsulant dam 162, which limits the flow of liquid encapsulant. Surface tension in the liquid encapsulant 152 causes the liquid encapsulant to form a convex shape dome shape over the optoelectronic element.

The encapsulant dam 162 can be made in a variety of ways. A sharp edge will act as sufficient retainer until the material is inverted. Any low surface energy surface will act as a dam by encouraging a large wetting angle with the dispensed material. The use of films or passivation layers to reduce surface energy is common. Mold release is a common term for material coatings that achieve this effect. In the case of an inverted lens, a primary advantage is that silicones go through a reduction in viscosity, or become more fluid and more likely to flow during heating before cross-linking occurs, which greatly increases the viscosity. Without inverted curing, normal dams can fail to hold the encapsulant during cure, as the material can flow over a sharp edge, for example when heated or given enough time. By filling the cavity and inverting during the cure, the lens shape may not only be enhanced, it may also be less prone to becoming compromised during the heating to cure cycle. When the dispensed lens material is applied in an inverted manner, features that could not otherwise “dam” or hold the shape boundaries may be able to do so due to the inversion of gravity forces.

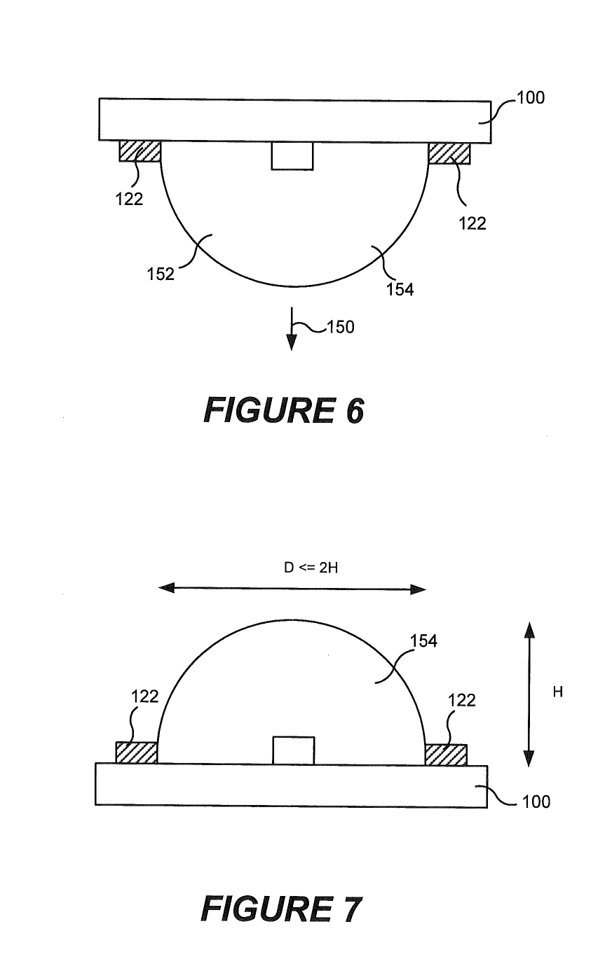

Referring to FIG. 6, before the liquid encapsulant material 52 is fully cured, the support substrate 100 is inverted, allowing the dispensed liquid encapsulant material 152 to be suspended from the support substrate 100. Surface tension of the liquid encapsulant material 152 and the adhesive nature of the liquid encapsulant material 152 cause the liquid encapsulant material to stick to the support substrate 100 even while the support substrate is inverted.

The force of gravity, indicated by arrow 150, causes the dispensed liquid encapsulant material 152 to pull into a more convex shape than occurs when the liquid encapsulant material 152 is cured in a normal (non-inverted) position.

The liquid encapsulant material 152 is then cured while the support substrate is inverted, for example, by heating the support substrate including the dispensed liquid encapsulant material in a furnace or oven at a sufficient temperature for a sufficient time for polymers in the liquid encapsulant to link together and solidify. The cured liquid encapsulant forms a solid dome lens 154 above the optoelectronic device.

As shown in FIG. 7, the solid dome lens 154 may have a more desirable aspect ratio than a conventional dome lens formed by liquid dispensing, and in some cases may be a near-perfect hemisphere. In some embodiments, the solid dome lens 154 may have a height H that is greater than or equal to about half the diameter D of the lens.

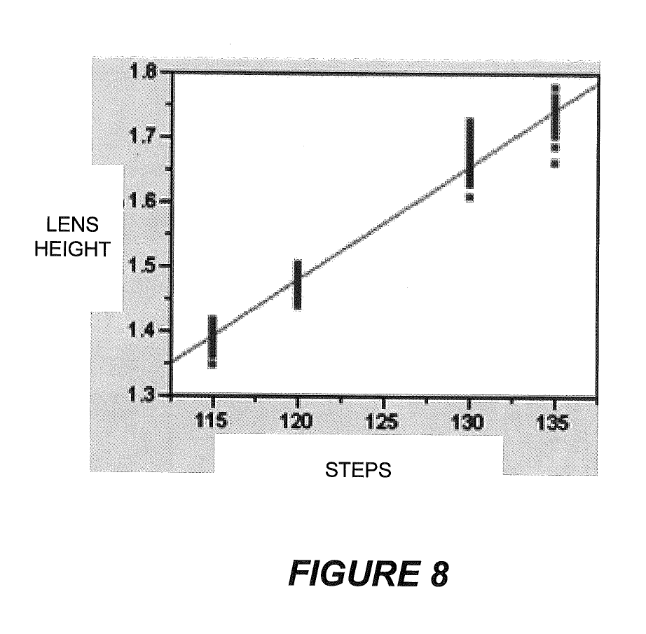

The height of the lens 154 is proportional to the amount of liquid dispensing material dispensed into the encapsulant area 126 for a given set of material properties. In particular, for typical optoelectronic package sizes, the height of the lens 154 is almost directly proportional to the amount of liquid dispensing material dispensed into the encapsulant area 126. For example, FIG. 8 is a graph of lens height as a function of the amount of liquid dispensed, in steps, for a plurality of lenses formed as described above. FIG. 8 shows the dependence of the lens height on amount of liquid dispensed. In particular, FIG. 8 shows that the average lens height in millimeters for each dispense level increases almost linearly with the number of dispense steps used. Each dispense step corresponds to approximately 0.1 microliters of liquid silicone. For example, a dispense of 115 steps (11.5 microliters) results in an average lens height of about 1.38 mm. A dispense of 130 steps (13.0 microliters) results in an average lens height of about 1.64 mm.

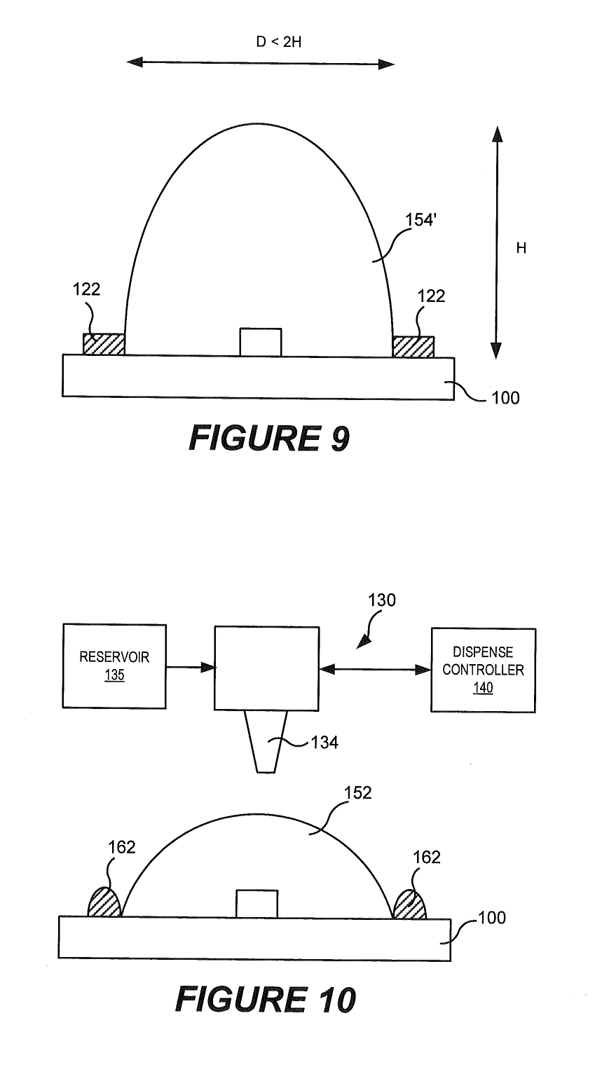

Lenses having even greater aspect ratios can be formed in accordance with some embodiments. For example, if a sufficient amount of liquid encapsulant material is dispensed, a lens 154′ having a bullet shape as shown in FIG. 9 may be formed. The lens 154′ may have a height H that is significantly more than half of the diameter D of the lens. A bullet shaped lens may be desirable for some applications, because such a lens shape may focus light emitted by the optoelectronic element 120, resulting in a different far-field optical pattern of emission.

Referring to FIG. 10, in some embodiments, an encapsulant dam 162 may be formed by dispensing a liquid polymer, such as a liquid silicone, onto the support substrate 100. The encapsulant dam 162 may be dispensed by the same dispensing system 130 as is used to dispense the liquid encapsulant 152, by a different dispensing system, and/or using the same dispensing system 130 but using a different dispensing needle 134 and/or reservoir.

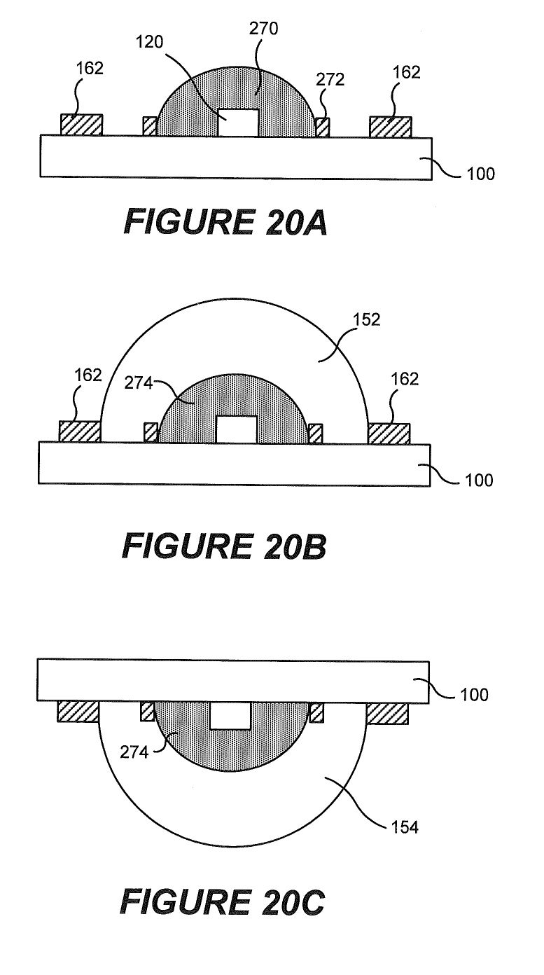

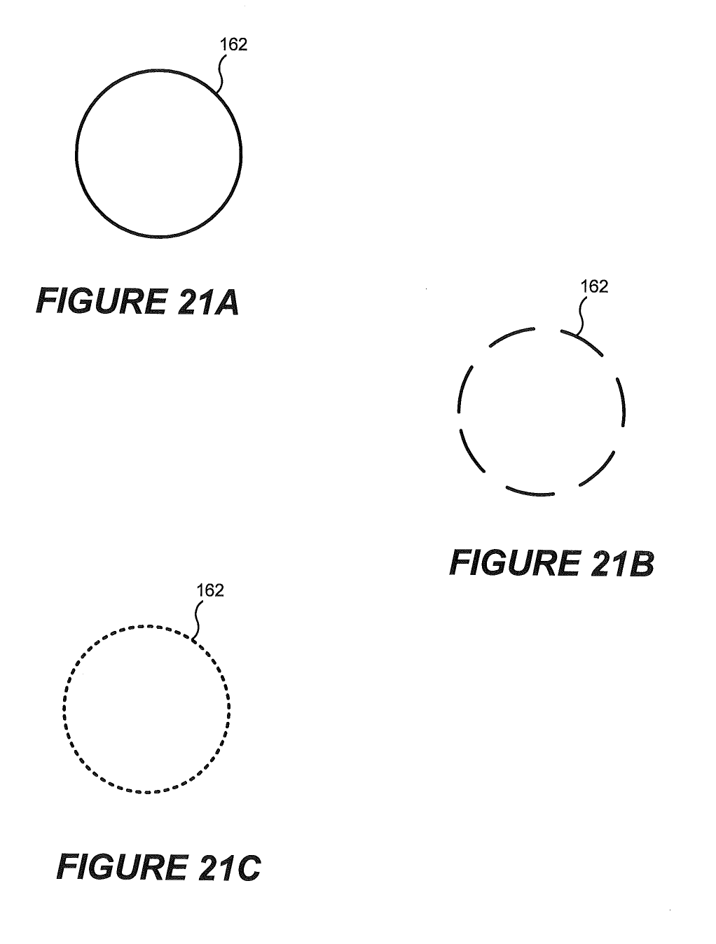

The liquid encapsulant dam 162 may be “drawn” onto the support substrate using the dispensing system by moving the dispensing nozzle around the support substrate 100 in a predetermined pattern under control of the dispense controller 140 while at the same time dispensing a desired quantity of liquid polymer material. The encapsulant dam 162 may be formed as a continuous closed shape (as shown in FIG. 21A), and/or as a discontinuous shape, e.g., a series of segments (FIG. 20B), dots (FIG. 21C), etc.

The dispensed encapsulant dam 162 may or may not be cured before dispensing the liquid encapsulant material 152. In some embodiments, the encapsulant dam 162 may be formed by heating a support substrate and then dispensing a liquid polymer onto the heated support substrate to cause the encapsulant dam to at least partially cure before dispensing the liquid encapsulant material 152.

To prevent or reduce the possibility that the dispensed liquid encapsulant material 152 will wet to the material used to form the dispensed encapsulant dam, the material of the encapsulant dam 162 may have a different surface energy than the material of the liquid encapsulant 152. For example, the liquid polymer dam 162 may be formed using a methyl silicone, while the liquid encapsulant material 152 may be a phenyl silicone. It is also observed that curing a polymer tends to reduce the surface energy which is favorable in the case of containing a dispensed liquid within.

Although not desiring to be bound by a particular theory, it is presently believed that the surface tension of the liquid encapsulant material 152 should be greater than the surface energy of the encapsulant/dam interface for the liquid encapsulant material 152 to hold its shape when it is dispensed onto an encapsulant region defined by a liquid encapsulant dam.

In some embodiments, a suitable encapsulant lens may be formed using 11.5 to 13 microliters dispensed in 0.1 microliter steps at 400 steps per second. Substantially larger lenses can be created using these methods. For example, lenses as large as 10 mm in diameter have been created using 2500 dispense steps at 400 steps/second and 0.1 microliters/step.

According to some embodiments, the dispensed lenses can be partially cured before being inverted, for example by heating the dispensed lenses at an elevated temperature for a period of time that is less than what would be required to fully cure the dispensed lenses. Furthermore, the lenses may be subjected to a final cure in a normal (non-inverted) orientation after an inverted curing process that does not fully cure the dispensed lens.

In one experiment, a large lens was fabricated by dispensing a phenyl silicone liquid encapsulant into a D-shaped encapsulant region defined by a methyl silicone liquid encapsulant dam having a maximum diameter of 10 mm without the aid of thixotropes. The liquid encapsulant was dispensed onto a support substrate using 2500 dispense steps at 400 steps/second and 0.1 microliters/step. The liquid encapsulant was cured in a normal orientation for 3.5 to 5 minutes at 110 degrees centigrade. The support substrate was inverted, and the dispensed encapsulant was further cured in an inverted orientation for 15 minutes at 110 degrees centigrade. The dispensed encapsulant was then subjected to a final cure with the support substrate in a normal orientation for 60 minutes at 150 degrees centigrade.

Another process used to cure a dispensed liquid encapsulant involved pre-curing the dispensed liquid encapsulant at 150 degrees centigrade with the support substrate in a normal orientation for 40 seconds and then curing the dispensed encapsulant with the support substrate in the inverted orientation at 150 degrees centigrade for 60 minutes.

As noted above, the encapsulant dam may be omitted in some embodiments. In some embodiments, the liquid encapsulant may be dispensed onto a heated support substrate without using surface features of the support substrate or dams to define the encapsulant area. Using a heated substrate, the encapsulant area is defined by the temperature of the heated substrate, the dispense rate of the encapsulant, and the “setup” time of the encapsulant. The size and shape of the encapsulant can also be precisely controlled by the dispense rate and dispense pattern. A heated support substrate can also be mounted inverted, with or without a dam, with the dispenser below the substrate to incorporate the effects of gravity. The temperature of the heated substrate depends on the curing properties of the encapsulant, but is typically in the range of 100 C to 150 C.

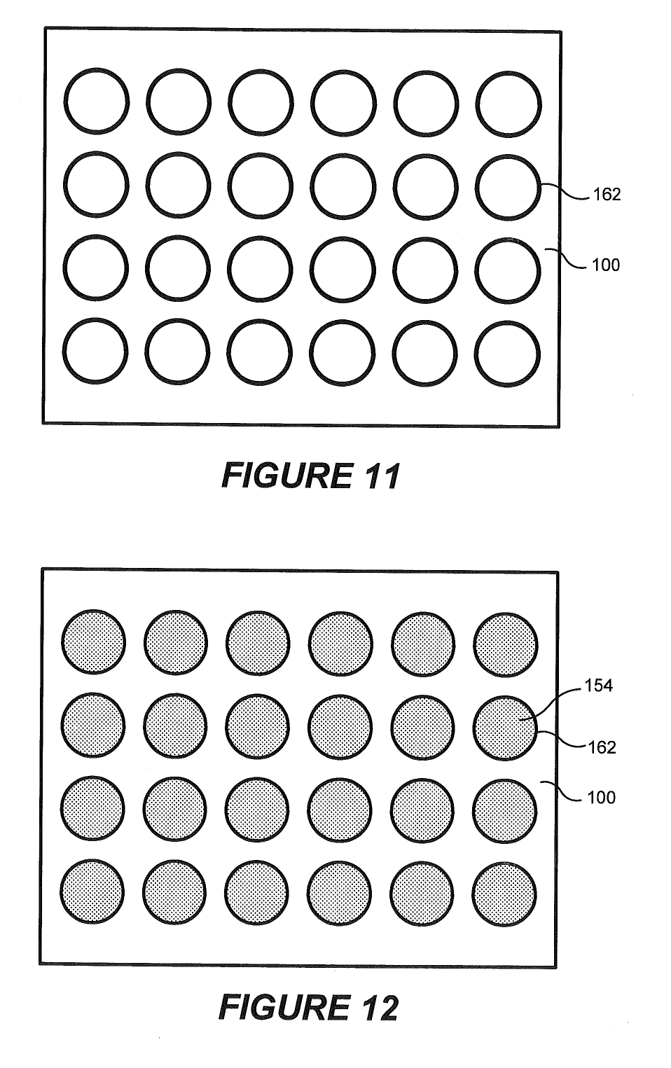

Referring to FIGS. 11 and 12, a support substrate 100 includes a plurality of encapsulant dams 162 formed thereon as shown in FIG. 11. In FIG. 12, a liquid encapsulant is dispensed within the regions defined by the encapsulant dams 162 to form hemispherical dome lenses 154. The portion of the support substrate 100 outside the dams 162 can be used for other purposes, such as for the attachment of other devices, since the dome lenses 154 are not formed by compression molding. Accordingly, a large number of devices can be fabricated on a single support substrate with very little of the support substrate surface area being wasted.

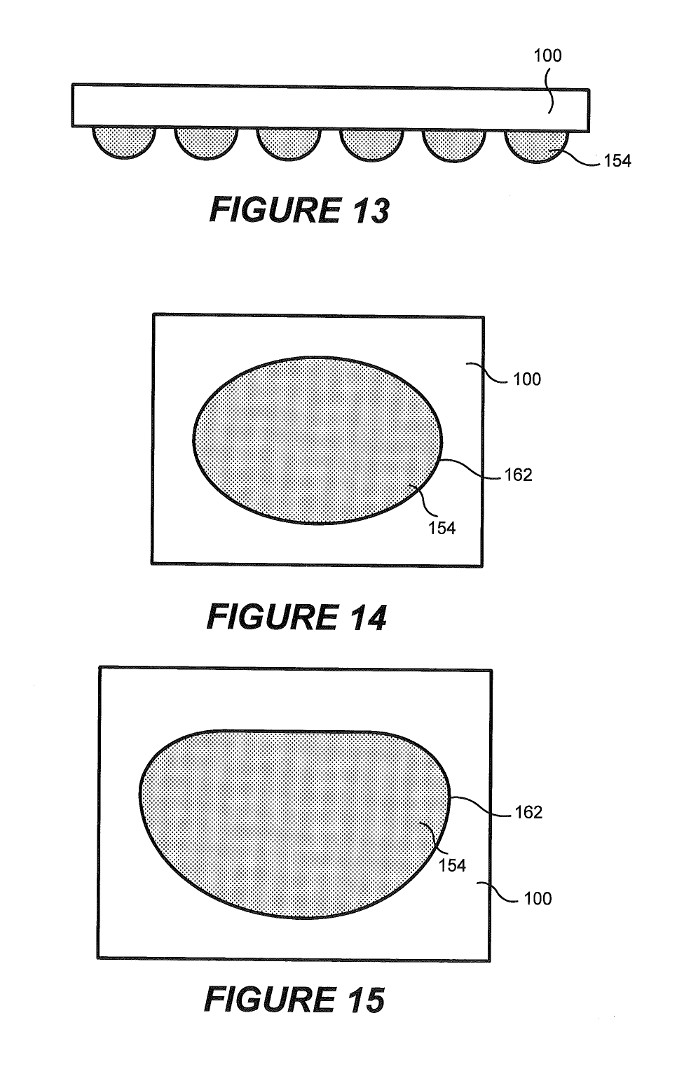

Referring to FIG. 13, after the encapsulant domes 154 have been dispensed, the support substrate is inverted, and the encapsulant domes 154 are cured in the inverted position.

Referring to FIGS. 14 and 15, the encapsulant dams 162 can be formed in any desired shape, such as oval (FIG. 14) or D-shaped (FIG. 15). The shape of the encapsulant dams is defined by the control instructions provided by the dispense controller 140 to the dispensing needle 134 in the dispensing system 130 used to dispense the liquid polymer material onto the support substrate 100 to define the in dams 162. Encapsulant dams can be drawn by hand for quick repair situations where the LED or component is embedded in a complex system. Encapsulant dams can also be discrete piece parts that are stuck on, glued on, etc. or even non-existent if the surface energy is low on the substrate. There are commercial products and methods to reduce the surface energy of surfaces with spray or wipe on products which leave a polymer film, or any polymer surface will act as a dam, such as soldermask, to varying degrees.

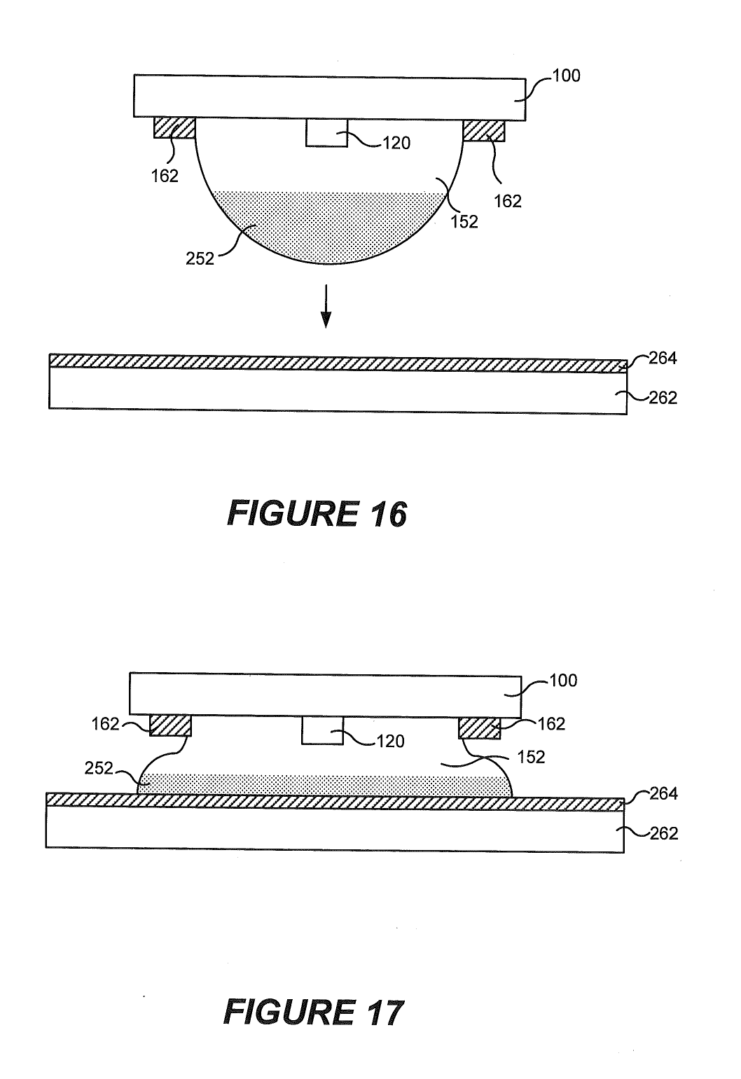

Further embodiments of the invention are illustrated in FIGS. 16 through 18. Referring to FIG. 16, a support substrate 100 is provided. An encapsulant dam 162 is provided on the support substrate 100 and defines an encapsulant region in which an optoelectronic device 120 is mounted. A liquid encapsulant 152 is dispensed into the in region defined by the dam 162, and the support substrate 100 is inverted. In the embodiments illustrated in FIGS. 16 through 18, a wavelength conversion material 252, such as a wavelength converting phosphor, is included in the encapsulant material 152. When the support substrate 100 is inverted, the wavelength conversion particles may be encouraged to settle using to the force of gravity towards the crest of the dome opposite the optoelectronic device 120. Conversely, settling can be discouraged or eliminated with the addition of thixotropes or the management of viscosity change. It will be appreciated, however, that the presence of wavelength conversion particles in the encapsulant material 152 is optional.

This separation of the wavelength conversion particles may have the effect of spacing the wavelength conversion material away from the optoelectronic device 120, which may be beneficial for the optical characteristics of the device.

In some embodiments, while the support substrate 100 is in the inverted position, the support substrate may be lowered into contact with a curing plate 262 on which a release film 264 is provided.

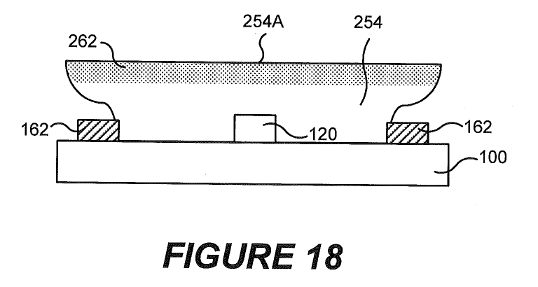

Referring to FIG. 17, when this happens, the encapsulant material 152 may spread out in contact with the release film 264. At the same time, the wavelength conversion material 252 contained within the encapsulant material 152 may spread out and form a layer of wavelength conversion material that has a flat profile relative to the support substrate 100. The encapsulant material 152 including wavelength conversion material may then be cured in this position so that when the curing plate 262 and release film 264 are separated from the support substrate 100, the encapsulant material is molded into the shape of an lens 254 that includes a flat upper surface 254A and a flat wavelength conversion region 262 that is spaced apart from the optoelectronic device 120 as shown in FIG. 18. As noted above, however, the wavelength conversion particles can be omitted from the encapsulant material. For example, the optoelectronic 120 could be coated with one or more wavelength conversion materials, and the lens 254 could be shaped as shown in FIG. 18 for the purpose of providing a desired emission pattern from the device.

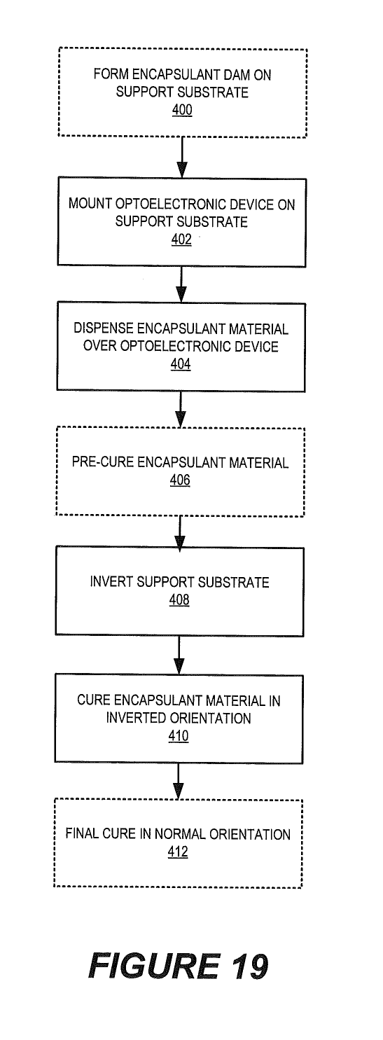

Operations according to some embodiments of the invention are illustrated in the flowchart of FIG. 19. Referring to FIG. 19, operations according to some embodiments include forming an encapsulant dam on a support substrate (block 400). The encapsulant dam is an optional feature, and may be omitted in some embodiments if the surface tension of the encapsulant is sufficient to hold it in place without a dam. However, the encapsulant dam may be desirable for maintaining the shape of the encapsulant dome when the support substrate is inverted as discussed above.

Next, an optoelectronic device is mounted on the support substrate (block 402). A liquid encapsulant material is then dispensed over the optoelectronic device (block 404). Optionally, the material may be pre-cured before inverting the support substrate (block 406). Next, the support substrate is inverted, so that the dispensed in material hangs from the support substrate (block 408). The encapsulant material is then cured while the support substrate is held in the inverted orientation (block 410). Finally, a final cure may be performed with the support substrate oriented in a normal orientation (block 412).

Further embodiments of the invention are illustrated in FIGS. 20A-20C. In some embodiments, such as for devices in which the LED emits light in the direction of the support substrate, it may be desirable for phosphor in the package to be positioned around the LED chip. Referring to FIG. 20A, an LED chip 120 is mounted on a support substrate 100. An encapsulant dam 162 is provided on the support substrate 100. A quantity of phosphor-loaded liquid encapsulant 270 is dispensed over the LED chip 120.

The phosphor-loaded liquid encapsulant 270 may be dispensed to cover the entire LED chip 120 or portions thereof. The phosphor-loaded liquid encapsulant 270 may or may not extend across the support substrate 100 to contact the encapsulant dam 162. In some embodiments, a second encapsulant dam 272 may be provided on the support substrate 100 within the first encapsulant dam 162, and may provide an anchor for the liquid encapsulant 270. However, the second encapsulant dam 272 may be omitted in some cases, as surface tension in the liquid encapsulant 270 and wetting to the LED chip 120 may keep the encapsulant in shape over the LED chip 120.

The phosphor-loaded liquid encapsulant 270 may then be at least partially cured to form a phosphor-loaded encapsulant dome 274.

Referring to FIG. 20B, a quantity of liquid encapsulant 152 is then dispensed over the LED chip 120 and the encapsulant dome 274. The liquid encapsulant 152 may be partially cured while the support substrate 100 is in a non-inverted orientation. Then, as shown in FIG. 20C, the support substrate 100 may be inverted, and the liquid encapsulant 152 may be partially or fully cured while the support substrate 100 is inverted to form an encapsulant dome 154.

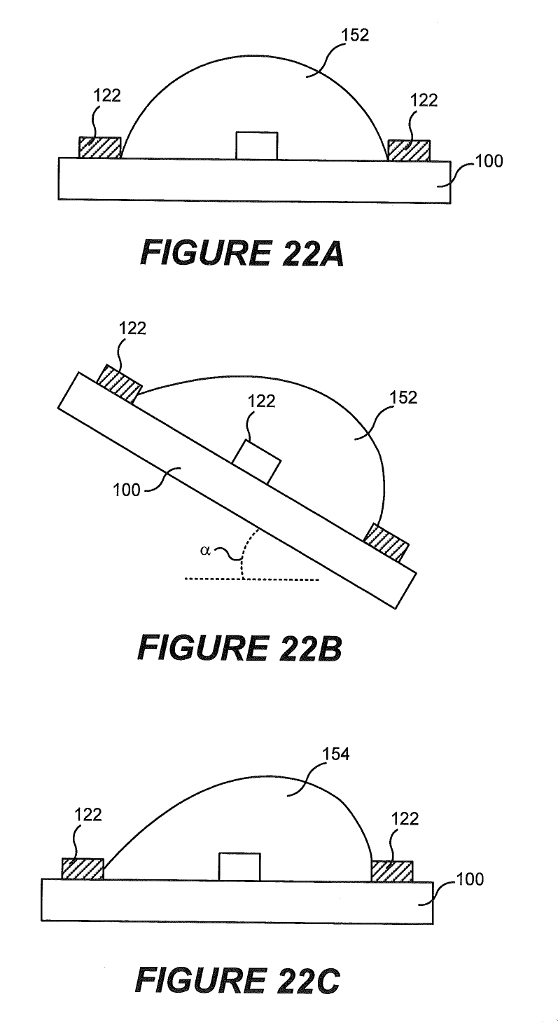

Other external forces can also be applied to the encapsulant before, during and/or after being inverted. Furthermore, the inversion need not be a complete 180 degree inversion of the support substrate. Rather, the support substrate may be partially tilted so that gravity causes the dispensed liquid encapsulant to take a desired shape upon curing. For example, referring to FIGS. 22A to 22C, after dispensing a liquid encapsulant 152 into an encapsulant region defined by an optional encapsulant dam 122, the support substrate 100 is tilted away from a normal vertical orientation by an angle α. As used herein, any tilting of the support substrate at an angle α>0, including 180 degree inversion of the support substrate, is referred to as a “non-normal” orientation. The liquid encapsulant 152 is then at least partially cured to form an asymmetric lens 154 above the light emitting diode 122. As used herein, an “asymmetric lens” is a lens that lacks symmetry about an axis normal to a planar surface on which a light emitting diode is mounted.

In some embodiments, the support substrate may be oriented in a first angular orientation (from 0 to 360 degrees of “roll” and/or “pitch”) and cured for a first period of time, then moved to a second angular orientation (again from 0 to 360 degrees of “roll” and/or “pitch”) and cured for a second period of time, etc., in order to obtain a lens with a desired shape. “Roll” and “pitch” refer to rotation of the device about two orthogonal axes that are parallel to the support substrate. For example, FIG. 22B illustrates rotation of the support substrate 100 about an axis that extends directly into the plane of the figure. In each case, the support substrate is oriented in a non-normal position and gravity is used to obtain a desired shape of the final cured lens.

Embodiments of the invention have been described herein with reference to cross-section illustrations that are schematic illustrations of idealized embodiments (and intermediate structures) of the invention. The thickness of layers and regions in the drawings may be exaggerated for clarity. Additionally, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Some embodiments of the present invention are described herein with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of forming an optoelectronic device, comprising:
providing an optoelectronic element on a support substrate;
dispensing a quantity of encapsulant onto the support substrate over the optoelectronic element;
inverting the support substrate so that the support substrate is above the optoelectronic element and the encapsulant is suspended from the support substrate; and
curing the encapsulant while maintaining the support substrate in the inverted position.

2. The method of claim 1, further comprising:
pre-curing the liquid encapsulant dome before inverting the support substrate.

3. The method of claim 1, further comprising:
providing an encapsulant dam on the support substrate, wherein the optoelectronic element is mounted within an encapsulant region bounded by the encapsulant dam;
wherein dispensing the quantity of liquid encapsulant comprises dispensing the quantity of liquid encapsulant within the encapsulant region.

4. The method of claim 3, wherein providing the encapsulant dam on the support substrate comprises dispensing a liquid polymer onto the support substrate in a pattern to define the encapsulant region.

5. The method of claim 4, wherein the pattern forms a circle on the support substrate.

6. The method of claim 4, wherein the pattern is non-circular.

7. The method of claim 4, wherein the liquid polymer comprises a silicone.

8. The method of claim 7, wherein the liquid encapsulant comprises a second silicone that is different than the silicone of the liquid polymer.

9. The method of claim 8, wherein the silicone of the liquid polymer has a different surface tension than the second silicone of the liquid encapsulant.

10. The method of claim 9, wherein the silicone of the liquid polymer comprises a methyl silicone and the second silicone of the liquid encapsulant comprises a phenyl silicone.

11. The method of claim 1, wherein the quantity of liquid encapsulant is large enough that when the liquid encapsulant cures, the dome formed by the liquid encapsulant has a height above the support substrate that is at least half of a maximum width of the dome.

12. The method of claim 1, wherein a height of the dome formed by the liquid encapsulant is greater than half of the maximum width of the dome.

13. The method of claim 1, further comprising:
bringing the encapsulant dome into contact with a curing plate while the support substrate is in the inverted position.

14. The method of claim 13, wherein the liquid encapsulant comprises wavelength conversion particles.

15. The method of claim 13, wherein curing the liquid encapsulant comprises curing the liquid encapsulant while the encapsulant dome is in contact with the curing plate.

16. The method of claim 15, further comprising heating the curing plate while the encapsulant dome is in contact with the curing plate.

17. A method of forming a lens for an optoelectronic device, comprising:
dispensing a quantity of encapsulant onto a support substrate;
inverting the support substrate so that the encapsulant is suspended from the support substrate; and
curing the encapsulant while maintaining the support substrate in the inverted position.

18. A method of forming an optical element, comprising:
providing a quantity of optical material on a support substrate; and
positioning the support substrate an a non-normal orientation to shape the optical element.
